(19) United States
(12) Patent Application Publication
(10) Pub. No.: US 2021/0036380 A1
(43) Pub. Date: Feb. 4, 2021

(54) NONAQUEOUS ELECTROLYTE SECONDARY BATTERY

(71) Applicant: SANYO Electric Co., Ltd., Daito-shi, Osaka (JP)

(72) Inventors: Tomomichi Ueda, Osaka (JP); Masahiro Nakamura, Osaka (JP); Atsushi Mizawa, Hyogo (JP)

(73) Assignee: SANYO Electric Co., Ltd., Daito-shi, Osaka (JP)

(21) Appl. No.: 16/969,277

(22) PCT Filed: Jan. 24, 2019
(86) PCT No.: PCT/JP2019/002316

§ 371 Date: Aug. 12, 2020

(30) Foreign Application Priority Data
Feb. 22, 2018 (JP) 2018-029644

(51) Int. Cl. H01M 10/0587; H01M 2/16; H01M 4/36; H01M 4/66

(52) U.S. Cl. CPC H01M 10/0587; H01M 4/66; H01M 4/364; H01M 2/1673

(57) ABSTRACT

In a nonaqueous electrolyte secondary battery according to one example of an embodiment, a winding type electrode body includes, at an outermost circumferential surface thereof, an exposed portion of a negative electrode collector and is provided with a tape which is adhered on the outermost circumferential surface from a winding-finish side end portion of a negative electrode and past a winding-finish end of the electrode body. The exposed portion is in contact with an inner circumferential surface of an exterior package can, and the tape has an easy-tear line formed in an extension portion extending from a position overlapping with the winding-finish end to a side opposite to an inner winding direction.

### TECHNICAL FIELD

The present disclosure relates to a nonaqueous electrolyte secondary battery.

### BACKGROUND ART

Heretofore, for example, in order to increase a capacity and to reduce an internal resistance, a nonaqueous electrolyte secondary battery has been known in which an exposed portion of a negative electrode collector is provided at an outermost circumferential surface of an electrode body having a winding structure and is brought into contact with an inner circumferential surface of an exterior package can functioning as a negative electrode terminal (for example, see PTLs 1 and 2). In general, to the outermost circumferential surface of the winding type electrode body, a winding-stop tape to maintain the winding structure of the electrode body is adhered (for example, see PTL 3).

### CITATION LIST

### Patent Literature

PTL 1: International Publication No. 2009/144919
PTL 2: International Publication No. 2016/147564
PTL 3: Japanese Published Unexamined Patent Application No. 2010-212086

### SUMMARY OF INVENTION

### Technical Problem

Incidentally, in order to easily insert an electrode body fixed by a winding-stop tape in an exterior package can, the electrode body is formed so as to generate a gap from an inner circumferential surface of the can. Accordingly, a preferable contact state between an exposed portion of a negative electrode collector provided at an outermost circumferential surface of the electrode body and the inner circumferential surface of the exterior package can is not easily realized. On the other hand, when the winding-stop tape is not used, the winding structure of the electrode body is loosened, and as a result, it is difficult to insert the electrode body in the exterior package can.

### Solution to Problem

A nonaqueous electrolyte secondary battery according to one aspect of the present disclosure is a nonaqueous electrolyte secondary battery comprising: a winding type electrode body which includes a positive electrode in which positive electrode mixture layers are formed on two surfaces of a positive electrode collector, a negative electrode in which negative electrode mixture layers are formed on two surfaces of a negative electrode collector, and at least one separator provided between the positive electrode and the negative electrode; and a bottom-closed cylindrical exterior package can which receives the electrode body. The electrode body has, at an outermost circumferential surface thereof, an exposed portion at which the negative electrode collector is exposed and is provided with a tape which is adhered on the outermost circumferential surface from a winding-finish side end portion of the negative electrode and past a winding-finish end of the electrode body, the exposed portion is in contact with an inner circumferential surface of the exterior package can, and the tape has an extension portion extending from a position overlapping with the winding-finish end of the electrode body to a side opposite to an inner winding direction and has at least one of an easy-tear portion and a tear-start portion in the extension portion.

### Advantageous Effects of Invention

According to the aspect of the present disclosure, in the nonaqueous electrolyte secondary battery including a winding type electrode body fixed by a winding-stop tape, a preferable contact state between the exposed portion of the negative electrode collector provided at the outermost circumferential surface of the electrode body and the inner circumferential surface of the exterior package can may be realized. Accordingly, for example, the internal resistance of the battery may be reduced.

### BRIEF DESCRIPTION OF DRAWINGS

FIG. 1 is a cross-sectional view of a nonaqueous electrolyte secondary battery which is one example of an embodiment.

FIG. 2 is a perspective view of an electrode body which is one example of the embodiment.

FIG. 3 is an enlarged view showing an easy-tear line of a tape and the vicinity thereof in the electrode body which is the example of the embodiment.

FIG. 4 is a view showing an electrode body which is another example of the embodiment.

FIG. 5 is a view showing an electrode body which is another example of the embodiment.

### DESCRIPTION OF EMBODIMENT

Hereinafter, one example of an embodiment according to the present disclosure will be described in detail. In the following description, as one example of the embodiment of a nonaqueous electrolyte secondary battery according to the present disclosure, although a cylindrical battery including a cylindrical battery case 15 will be described by way of example, a square battery including a square battery case, a laminate battery including a battery case formed of a laminate sheet in which at least one metal layer and at least one resin layer are laminated to each other, or the like may also be used as the battery. In addition, in this specification, for the convenience of illustration, a sealing body 17 side and a bottom portion side of an exterior package can 16 of the battery case 15 are described as “upper side” and “lower side”, respectively.

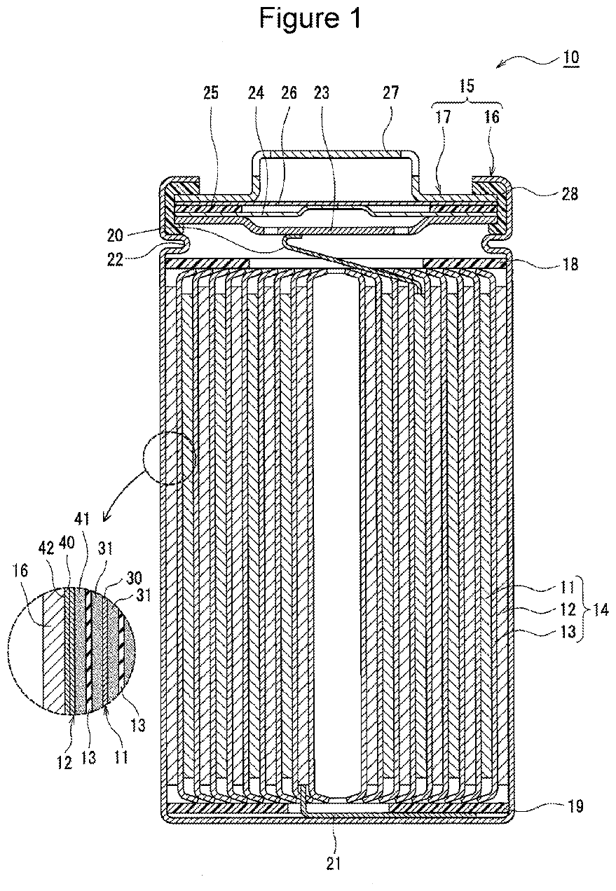

FIG. 1 is a cross-sectional view of a nonaqueous electrolyte secondary battery 10 which is one example of the embodiment. As shown in FIG. 1, the nonaqueous electrolyte secondary battery 10 comprises an electrode body 14, a nonaqueous electrolyte (not shown), and a battery case 15 receiving the electrode body 14 and the nonaqueous electrolyte. The electrode body 14 is formed of a positive electrode 11 in which positive electrode mixture layers 31 are formed on two surfaces of a positive electrode collector 30, a negative electrode 12 in which negative electrode mixture layers 41 are formed on two surfaces of a negative electrode collector 40, and at least one separator provided between the positive electrode II and the negative electrode 12. The electrode body 14 has a winding structure in which the positive electrode 11 and the negative electrode 12 are wound with the separator 13 provided therebetween. The battery case 15 is formed of a bottom-closed cylindrical exterior package can 16 and a sealing body 17 which seals an opening portion of the exterior package can 16. In addition, the nonaqueous electrolyte secondary battery 10 includes a resin-made gasket 28 disposed between the exterior package can 16 and the sealing body 17.

The nonaqueous electrolyte contains a nonaqueous solvent and an electrolyte salt dissolved in the nonaqueous solvent. As the nonaqueous solvent, for example, there may be mentioned an ester, an ether, a nitrile, an amide, or a mixed solvent containing at least two of those mentioned above. The nonaqueous solvent may also include a halogen substitute in which at least one hydrogen atom of each of those solvents mentioned above is replaced by a halogen atom, such as fluorine. In addition, the nonaqueous electrolyte is not limited to a liquid electrolyte, and a solid electrolyte using a gel polymer or the like may also be used. As the electrolyte salt, for example, a lithium salt, such as LiPF₆, is used.

The electrode body 14 is formed of a long positive electrode 11, a long negative electrode 12, two long separators 13, a positive electrode lead 20 bonded to the positive electrode 11, and a negative electrode lead 21 bonded to the negative electrode 12. In order to suppress precipitation of lithium, the negative electrode 12 is formed one size larger than the positive electrode 11. That is, the negative electrode 12 is formed longer than the positive electrode 11 in a longitudinal direction and in a short direction (up-down direction). The two separators 13 are each formed at least one size larger than the positive electrode 11, for example, so as to sandwich the positive electrode 11.

On the top and the bottom of the electrode body 14, insulating plates 13 and 19 are disposed, respectively. In the example shown in FIG. 1, the positive electrode lead 20 fitted to the positive electrode 11 extends to a sealing body 17 side through a through-hole of the insulating plate 18, and the negative electrode lead 21 fitted to the negative electrode 12 extends to a bottom portion side of the exterior package can 16 through a through-hole of the insulating plate 19. The positive electrode lead 20 is connected to a bottom surface of a filter 23 functioning as a bottom plate of the sealing body 17 by welding or the like, and a cap 27 functioning as a top plate of the sealing body 17 electrically connected to the filter 23 is used as a positive electrode terminal. The negative electrode lead 21 is connected to an inner surface of the bottom portion of the exterior package can 16 by welding or the like, and the exterior package can 16 is used as a negative electrode terminal.

The exterior package can 16 is a bottom-closed cylindrical metal-made container. The gasket 28 is provided between the exterior package can 16 and the sealing body 17, and an inner space of the battery case 15 is sealed. The exterior package can 16 has a groove portion 22 to support the sealing body 17, the groove portion being formed, for example, by pressing a side surface portion from the outside. The groove portion 22 is preferably formed to have a ring shape along a circumferential direction of the exterior package can 16, and an upper surface of the groove portion 22 supports the sealing body 17. in addition, an upper end portion of the exterior package can 16 is bent inside and is caulked with a circumferential portion of the sealing body 17.

The sealing body 17 has the structure in which the filter 23, a lower valve 24, an insulating member 25, an upper valve 26, and the cap 27 are laminated in this order from an electrode body 14 side. The members forming the sealing body 17 each have, for example, a disc shape or a ring shape and are electrically connected to each other except for the insulating member 25. The lower valve 24 and the upper valve 26 are connected to each other at the central portions thereof, and between the peripheral portions thereof, the insulating member 25 is provided. When an inside pressure of the battery is increased, since the lower valve 24 is deformed so as to push up the upper valve 26 toward a cap 27 side and is fractured, an electric current path between the lower valve 24 and the upper valve 26 is blocked. When the inside pressure is further increased, the upper valve 26 is fractured, and a gas is exhausted from an opening portion of the cap 27.

In the example shown in FIG. 1, the positive electrode lead 20 is provided at a longitudinal-direction central portion of the positive electrode 11 and a position apart from a winding-start side end and a winding-finish side end of the electrode body 14. On the other hand, the negative electrode lead 21 is provided at a longitudinal-direction end portion of the negative electrode 12 located at a winding-start side of the electrode body 14. In addition, the arrangement of the electrode leads is not particularly limited.

The positive electrode 11 includes a belt-shaped positive electrode collector 30 and positive electrode mixture layers 31 formed on two surfaces of the collector. In the positive electrode 11, for example, at a longitudinal-direction central portion of the collector, an exposed portion at which the surface of the positive electrode collector is exposed is formed, and the positive electrode lead 20 is bonded to this exposed portion. The positive electrode mixture layer 31 is formed from a positive electrode active material, an electrically conductive agent, and a binder. As the positive electrode active material, for example, a lithium composite metal oxide containing at least one transition metal selected from Co, Mn, and Ni may be mentioned. The lithium composite metal oxide may also contain a different metal element, such as Al, Mg, or Zr.

The negative electrode 12 includes a belt-shaped negative electrode collector 40 and negative electrode mixture layers 41 formed on two surfaces of the collector. The negative electrode mixture layer 41 is formed from a negative electrode active material and a binder and if needed, may also contain an electrically conductive agent. As the negative electrode active material, any material capable of reversibly occluding and releasing lithium ions may be used, and for example, there may be used a carbon material, such as a natural graphite or an artificial graphite, a lithium titanium composite oxide, a metal, such as Si or Sn, forming an alloy with lithium, or an alloy or an oxide containing the metal mentioned above.

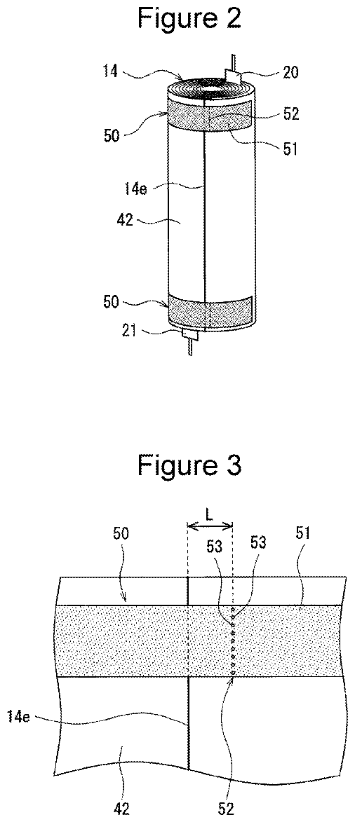

The electrode body 14 has, at an outermost circumferential surface thereof, an exposed portion 42 at which the surface of the negative electrode collector 40 is exposed and is provided with a tape 50 (see FIG. 2 which will be described later) adhered on the outermost circumferential surface from a winding-finish side end portion of the negative electrode 12 and past a winding-finish end 14e of the electrode body 14. In the nonaqueous electrolyte secondary battery 10, since the exposed portion 42 is in contact with the inner surface of the exterior package can 16 functioning as the negative electrode terminal, the two end portions of the negative electrode 12 in a longitudinal direction and the negative electrode terminal are electrically connected to each other, and a preferable current collection property can be secured. In addition, by the contact between the exposed portion 42 and the exterior package can 16, since the electrical connection between the negative electrode 12 and the negative electrode terminal is secured, the structure in which no negative electrode lead 21 is provided may also be formed. In this case, the volume of the electrode body 14 can be increased in an amount corresponding to the thickness of the lead, and hence, the capacity of the battery can be increased.

The exposed portion 42 may be provided at a part of the outermost circumferential surface of the electrode body 14 and, for example, the separator 13 extending from an inner winding surface (surface facing the inside of the electrode body 14) of the winding-finish side end of the negative electrode 12 may be present at a part of the outermost, circumferential surface of the electrode body 14. In this embodiment, in the state in which the tape 50 is not adhered, the exposed portion 42 is provided over the entire region of the outermost circumferential surface of the electrode body 14. In addition, a portion in which the negative electrode mixture layers 41 are not formed on the two surfaces of the negative electrode collector 40 is provided from the winding-finish end 14e to have a length corresponding to one circumferential length of the electrode body 14 or more. However, the exposed portion 42 may also be provided such that a portion in which the negative electrode mixture layer 41 is not formed only on an outer winding surface (surface facing the outside of the electrode body 14) of the negative electrode collector 40 is disposed at the outermost circumferential surface of the electrode body 14.

For the separator 13, a porous sheet having an ion permeability and an insulating property may be used. The separator 13 may have either a monolayer structure or a multilayer structure and may be formed of a polyolefin resin, such as a polyethylene or a polypropylene, or a cellulose. When a polyolefin resin is used, a heat resistance layer may be provided on a substrate surface formed of a polyolefin resin by applying a resin, such as an aramid resin, having a high heat resistance. The heat resistance layer may also be provided using a resin containing ceramic particles.

Hereinafter, with reference to FIGS. 2 and 3, the electrode body 14, in particular, the tape 50 to be adhered on the outermost circumferential surface of the electrode body 14, will be described in detail. FIG. 2 is a perspective view of the electrode body 14, and FIG. 3 is an enlarged view of an easy-tear line 52 of the tape 50 and the vicinity thereof.

As shown in FIGS. 2 and 3 by way of example, the tape 50 is adhered from the winding-finish side end portion (winding-finish side end and the vicinity thereof) of the negative electrode 12 and past the winding-finish end 14e of the electrode body 14. The tape 50 is a winding-stop tape to maintain the winding structure of the electrode body 14. Since the winding-finish side end portion of the negative electrode 12 is fixed using the tape 50, the winding structure of the electrode body 14 is maintained, and for example, in a battery manufacturing process, the electrode body 14 can be smoothly received in the exterior package can 15. Although the details will be described later, in the tape 50, at least one of an easy-tear portion and a tear-start portion is formed.

In this embodiment, since the exposed portion 42 is provided over the entire region of the outermost circumferential surface of the electrode body 14, the winding-finish side end of the negative electrodes is the winding-finish end 14e of the electrode body 14. In the case in which since the separator 13 extends from the inner winding surface of the winding-finish side end of the negative electrode 12, the separator 13 is present at a part of the outermost circumferential surface of the electrode body 14, a winding-finish side end of the separator 13 is the winding-finish end 14e.

The tape 50 includes a substrate layer formed, for example, from an insulating organic material and an adhesive layer having an adhesive property to the electrode body 14. The tape 50 is preferably an insulating tape having substantially no electrically conductive property. The tape 50 may have a multilayer structure having at least three layers, and the substrate layer may be formed of a laminate film including at least two layers formed from the same type of material or different types of materials. The thickness of the tape 50 is, for example, 10 to 60 μm and preferably 15 to 40 μm. In addition, in the tape 50, an inorganic filler of titania, alumina, silica, zirconia, or the like may be contained, and besides the substrate layer and the adhesive layer, a layer containing an inorganic filler may also be provided.

As a preferable resin forming the substrate layer, for example, there may be mentioned a polyester, such as a poly(ethylene terephthalate) (PET), a polypropylene (PP), a polyimide (PI), a poly(phenylene sulfide) (PPS), a poly(ether imide) (PEI), or a polyamide. The adhesive layer is formed, for example, by applying an adhesive on one surface of the substrate layer. Although the adhesive forming the adhesive layer may be a hot-melt type having an adhesive property by heating or a thermosetting type to be cured by heating, in view of the productivity and the like, an adhesive having an adhesive property at room temperature is preferable.

Although the tape 50 may have a shape in which the length along an axial direction of the electrode body 14 is longer than the length in a circumferential direction of the electrode body 14, the tape 50 is preferably formed to have a long and thin belt shape and is adhered so that a longitudinal direction thereof is along the circumferential direction of the electrode body 14. Along the circumferential direction of the electrode body 14, the tape 50 is preferably adhered to at least 50% of the circumferential length of the outermost circumferential surface and is more preferably adhered to 80% to 100% thereof. The tape 50 has, in general, a predetermined width. The width of the tape 50 is, for example, 5 to 12 mm.

As described above, the tape 50 is adhered to the exposed portion 42 so as to extend past the winding-finish end 14e. In this specification, a portion of the tape 50 which extends from a position overlapping with the winding-finish end 14e of the electrode body 14 to a side opposite to an inner winding direction is called an extension portion 51. In the exposed portion 51, the tape 50 is adhered to a portion apart from, for example, the winding-finish end of the negative electrode 12 in the inner winding direction by at least 80% to 100% of the circumferential length of the outermost circumferential surface along the circumferential direction (longitudinal direction of the negative electrode 12) of the electrode body 14.

Although the tape 50 may be adhered to only an axial-direction central portion of the electrode body 14, the tape 50 is preferably adhered to at least one of the two axial-direction end portions. In more particular, the tape 50 is preferably adhered to a region of 15 mm from at least one of the two axial-direction ends of the electrode body 14. Of the two axial-direction end portions of the electrode body 14, the tape 50 may be adhered to only the end portion at a bottom portion side of the exterior package can 16. Since the tape 50 is adhered to the end portion at the bottom portion side of the exterior package can 16, when the electrode body 14 is inserted in the exterior package can 16, the end portion can be prevented from being brought into contact with the exterior package can 16, and as a result, turn-up, breakage, damage, and the like of an electrode plate can be prevented from being generated.

Although the tape 50 may be adhered to a wide region of the outermost circumferential surface including the axial-direction central portion and the two axial-direction end portions of the electrode body 14, the tape 50 is preferably adhered to only at. least one of the two axial-direction end portions, and in particular, to only a region of 15 mm from at least one of the two axial-direction end portions. When being adhered to only one of the two axial-direction end portions of the electrode body 14, the tape 50 is adhered to the end portion at the bottom portion side of the exterior package can 16. When the tapes 50 are adhered to only the two axial-direction end portions of the electrode body 14, the insertion of the electrode body 14 in the exterior package can 16 can be smoothly performed, and in addition, a contact area between the exposed portion 42 and an inner circumferential surface of the exterior package can 16 can be increased. In addition, when the electrode body 14 is fixed by the tape 50, the electrode plate may be deformed in some cases by expansion in association with charge/discharge; however, when the tape 50 is adhered to a place other than the axial-direction central portion of the electrode body 14, the deformation of the electrode plate can be suppressed.

In the example shown in FIG. 2, the tapes 50 are adhered to the two axial-direction end portions of the electrode body 14. Although the two tapes 50 may have different shapes and different dimensions from each other, in general, tapes having the same shape and the same dimension are used. Although the tape 50 may be adhered so that the end of the tape 50 is flush with each of the two axial-direction ends of the outermost circumferential surface of the electrode body 14, the end of the tape 50 is preferably adhered so as not to extend past each of the two axial-direction ends. Hence, in consideration of an adhesion error, the tape 50 is adhered with a predetermined space between the end thereof and each of the two axial-direction ends and is preferably adhered with a space of 2 mm or less therebetween.

In the extension portion 51 of the tape 50 extending from the position overlapping with the winding-finish end 14e of the electrode body 14 to a side opposite to the inner winding direction, an easy-tear line 52 is formed as an easy-tear portion which is likely to be torn as compared to the other portion. When the electrode body 14 is expanded by charge/discharge of the battery, the tape 50 is torn, for example, along the easy-tear line 52. That is, the easy-tear line 52 may be called a tear-scheduled portion. However, when the electrode body 14 is expanded, the easy-tear line 52 may partially function as a tear-start point, and the tape 50 is not required to be torn all along the entire length of the easy-tear line 52.

Since the easy-tear line 52 to be torn by the expansion of the electrode body 14 is formed in the tape 50, after the electrode body 14 is inserted in the exterior package can 16, when the winding structure of the electrode body 14 is loosened, the outside diameter thereof can be increased. Accordingly, a preferable contact state between the exposed portion 42 of the negative electrode collector 40 provided at the outermost circumferential surface of the electrode body 14 and the inner circumferential surface of the exterior package can 16 can be realized, and as a result, the internal resistance of the battery can be reduced. That is, since the tape 50 having the easy-tear line 52 is used, a preferable inserting property of the electrode body 14 in the exterior package can 16 and a preferable contact state between the exposed portion 42 and the inner circumferential surface of the exterior package can 16 can be simultaneously achieved.

The easy-tear line 52 is formed by a plurality of through-holes 53 (see FIG. 3) linearly disposed along the axial direction of the electrode body 14. The easy-tear line 52 is also called a perforated line, and in the easy-tear line 52, the through-holes 53 and portions at which the through-holes 53 are not formed are alternately disposed. By changing the sizes, the intervals, and the like of the through-holes 53, tearing characteristics of the easy-tear line 52 may be controlled. The shape of the through-hole 53 is not particularly limited, and for example, a perfect circular shape, an oval shape, a long hole shape, or a thin line shape may be used.

One example of the size (diameter of the circumscribed circle) of the through-hole 53 is approximately 0.1 to 1 mm. In addition, one example of the interval between the through-holes 53 is approximately 0.1 to 1 mm. In the example shown in FIG. 2, although being formed with regular intervals, the through-holes 53 may be not provided with regular intervals. For example, the interval between the through-holes 53 formed at each of two width-direction end portions of the tape 50 may be set to be smaller than the interval between the through-holes 53 formed at a width-direction central portion of the tape 50.

In the example shown in FIG. 3, the easy-tear line 52 in which the through-holes 53 are disposed with regular intervals is formed over the entire width of the tape 50. In addition, the easy-tear portion may be a portion to be torn by the expansion of the electrode body 14, and for example, the easy-tear portion may be formed at only at least one of the two width-direction end portions of the tape 50. Alternatively, the easy-tear portion may be formed at only the width-direction central portion of the tape 50. In addition, the easy-tear portion may be a half-cut line formed by partially cutting the tape 50 in a thickness direction or may be formed using through-holes and a half cut line in combination.

In the extension portion 51 of the tape 50, the easy-tear line 52 is preferably formed in a region of 1 mm from a position overlapping with the winding-finish end 14e of the electrode body 14 in the circumferential direction. That is, a length L from the winding-finish end 14e to the easy-tear line 52 along the circumferential direction of the electrode body 14 is preferably 1 mm or less. Since the easy-tear line 52 is formed in the region described above, when the electrode body 14 is expanded, the tape 50 can be easily torn. The easy-tear line 52 is further preferably formed in a region of 0.5 mm from the position overlapping with the winding-finish end 14e. The easy-tear line 52 may be formed at the position overlapping with the winding-finish end 14e. The easy-tear line 52 is formed, for example, in a region of 1 mm from the position overlapping with the winding-finish end 14e so as to be parallel with the winding-finish end 14e.

The easy-tear line 52 may be formed using a blade, such as a die cut roller, or a laser. In general, when the tape 50 is adhered on the outermost circumferential surface of the electrode body 14, a long tape 50 is supplied, and immediately before being adhered to the electrode body 14, the long tape 50 is cut into individual tape sizes. In an adhesion step of the tape 50, a long tape 50 in which easy-tear lines 52 are formed in advance may be supplied, or immediately before the tape 50 is adhered to the electrode body 14, the easy-tear line 52 may be formed therein. According to the latter method, the tape 50 can be suppressed from being torn in the manufacturing process.

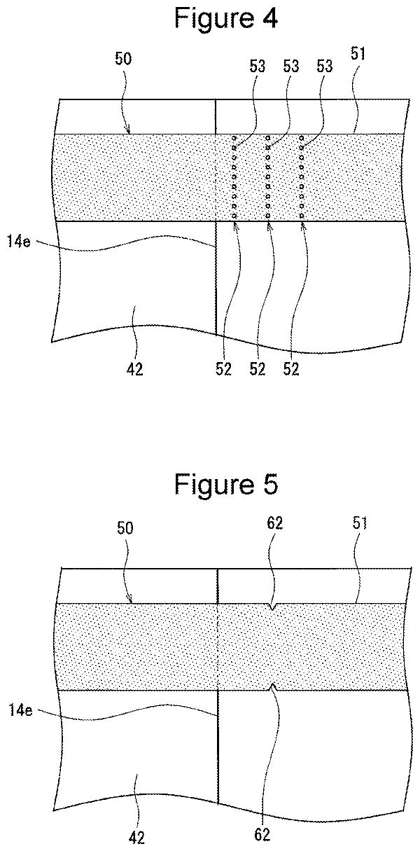

As shown in FIG. 4 by way of example, the number of easy-tear lines 52 may be set to at least two. When a plurality of easy-tear lines 52 is formed, at least two lines are preferably formed in a region of 1.5 mm from the position overlapping with the winding-finish end 14e of the electrode body 14 in the circumferential direction. In the region of 1.5 mm from the position overlapping with the winding-finish end 14e of the extension portion 51 (that is, from the end of the extension portion 51), two to three easy-tear lines 52 are formed, and two easy-tear lines 52 are preferably formed. At least two easy-tear lines 52 may be formed in a region of 1 mm from the position overlapping with the winding-finish end 14e. In addition, the easy-tear lines 52 may be formed, besides in the extension portion 51, also in a portion other than the extension portion 51.

The easy-tear lines 52 are formed only in the vicinity of the portion overlapping with the winding-finish end 14e with regular intervals in the circumferential direction of the electrode body 14. Alternatively, the easy-tear lines 52 may be formed over the entire length of the tape 50. Although being not particularly limited, the interval between the easy-tear lines 52 is preferably 0.5 to 1.5 mm. The easy-tear lines 52 are formed, for example, in parallel to each other with regular intervals. Since being formed as described above, the easy-tear lines 52 are easily disposed in the vicinity of the winding-finish end 14e of the extension portion 51.

As shown in FIG. 5 by way of example, instead of the easy-tear line 52, notches 62 each of which is a tear-start portion functioning as a tear-start point may be formed. The notch 62 is a notch formed at an end portion of the tape 50 and has a triangle shape. In this case, when the electrode body 14 is expanded by charge/discharge, the tape 50 is torn from the apex of the triangle of the notch 62. In the example shown in FIG. 5, two notches 62 are formed at two width-direction end portions of the tape 50 so as to be disposed in the width direction. When the electrode body 14 is expanded, for example, the tape 50 is torn along a linear line to be formed between the two notches 62. That is, the linear line may be regarded as a tear-scheduled portion (easy-tear portion). However, as long as the notch 62 functions as the tear-start point, the tape 50 may not be torn along the linear line described above.

As is the case of the easy-tear line 52, in the extension portion 51 of the tape 50, the notch 62 is preferably formed in a region of 1 mm from the position overlapping with the winding-finish end 14e of the electrode body 14 in the circumferential direction or preferably in a region of 0.5 mm therefrom. In addition, in the circumferential direction of the electrode body 14, at least two notches 62 may be formed with regular intervals in the vicinity of the portion overlapping with the winding-finish end 14e or over the entire length of the tape 50.

The tear-start portion is not limited to the triangle-shaped notch 62 and may be formed to have a thin line shape from the end of the tape 50. In addition, in the tape 50, the easy-tear line and the notch may be both formed. For example, two notches are formed at the two width-direction ends of the tape 50 and, between the notches, a perforated line formed of through-holes or a half-cut line may also be formed. In addition, in the tape 50 having an easy-tear portion, when the electrode body 14 is expanded, a part (such as a rim portion of the through-hole) of the easy-tear portion functions as the tear-start. portion. The easy-tear portion and the tear-start portion are each a portion to tear the tape 50 when the electrode body 14 is expanded and are not required to be clearly discriminated from each other.

In the nonaqueous electrolyte secondary battery 10, as described above, the exposed portion 42 of the negative electrode collector 40 provided at the outermost circumferential surface of the electrode body 14 is in contact with the inner circumferential surface of the exterior package can 16. When the electrode body 14 is expanded, since the tape 50 is torn by the function of the easy-tear line 52, the notch 62, or the like, the winding structure of the electrode body 14 is loosened, and the diameter thereof is increased, so that a preferable contact state is formed between the exposed portion 42 and the inner circumferential surface of the exterior package can 16. Although the exposed portion 42 may be in contact with the inner circumferential surface of the exterior package can 16 before the tape 50 is torn, since the tape 50 is torn, a more preferable contact state can be obtained. The tape 50 is, in general, torn in the first charge/discharge.

### EXAMPLES

Hereinafter, although the present disclosure will be further described with reference to Examples, the present disclosure is not limited thereto.

### Example 1

### [Formation of Positive Electrode]

As a positive electrode active material, a lithium metal composite oxide represented by LiNi_{0.38}Co_{0.09}Al_{0.03}O₂ was used. After 100 parts by mass of the positive electrode active material, 1 part by mass of acetylene black, and 0.9 parts by mass of a poly(vinylidene fluoride) were mixed together, an appropriate amount of N-methyl-2-pyrrolidone was added, so that a positive electrode mixture slurry was prepared. Subsequently, the positive electrode mixture slurry was applied to two surfaces of a long positive electrode collector formed from aluminum foil, and coating films thus formed were dried. After the coating films were compressed using rollers, cutting was performed to obtain a predetermined electrode size, so that a positive electrode in which positive electrode mixture layers were formed on the two surfaces of the positive electrode collector was formed. At a longitudinal-direction central portion of the positive electrode, an exposed portion at which no mixture layers were present and at which the surface of the collector was exposed was provided, and an aluminum-made positive electrode lead was then welded to the exposed portion.

### [Formation of Negative Electrode]

As a negative electrode active material, a mixture of 95 parts by mass of a graphite powder and 5 parts by mass of a Si oxide was used. After 100 parts by mass of the negative electrode active material, 1 part by mass of a sodium carboxymethyl cellulose, and 1 part by mass of a dispersion of a styrene-butadiene rubber were mixed together, an appropriate amount of water was added, so that a negative electrode mixture slurry was prepared. Subsequently, the negative electrode mixture slurry was applied to two surfaces of a long negative electrode collector formed from copper foil, and coating films thus formed were dried. After the coating films were compressed using rollers, cutting was performed to obtain an electrode size, so that a negative electrode in which negative electrode mixture layers were formed on the two surfaces of the negative electrode collector was formed. At two longitudinal-direction end portions of the negative electrode, exposed portions at each of which no mixture layers were present and the surface of the collector was exposed were provided, and a nickel-made negative electrode lead was welded to the exposed portion at one longitudinal-direction end portion (end potion located at a winding-start side of an electrode body).

### [Formation of Electrode Body]

The positive electrode and the negative electrode were wound with separators each formed from a polyethylene-made fine porous film interposed therebetween, so that a winding type electrode body was formed. The exposed portion at which the surface of the negative electrode collector was exposed was provided over the entire region of an outermost circumferential surface of the electrode body, and tapes were adhered to the exposed portion past a winding-finish end of the electrode body (winding-finish end of the negative electrode). For the tape, a polypropylene-made adhesive tape having a thickness of 30 μm, a width of 9 mm, and a length of 50 mm was used. As shown in FIG. 2, the two tapes were each adhered to only a region of 15 mm from one of the two axial-direction end portions of the electrode body. In an extension portion of the tape, an easy-tear line was formed at a position apart from a position overlapping with the winding-finish end of the electrode body by 1 mm. The easy-tear line was formed such that circular through-holes each having a diameter of 1 mm were formed in the width direction of the tape with 1-mm intervals.

### [Preparation of Nonaqueous Electrolyte]

Ethylene carbonate (EC) and dimethyl carbonate (DMC) were mixed together at an EC/DMC volume ratio of 1:3. To this mixed solvent, 5 percent by mass of vinylene carbonate was added, and LiPF₆ was dissolved therein at a concentration of 1.5 mol/L, so that a nonaqueous electrolyte liquid was prepared.

### [Formation of Battery]

On the top and the bottom of the electrode body, insulating plates were disposed, and the electrode body was received in an exterior package can. Subsequently, a negative electrode lead was welded to a bottom inner surface of the bottom-closed cylindrical exterior package can, and a positive electrode lead was welded to a sealing body. Finally, the nonaqueous electrolyte liquid was charged in the exterior package can, and an opening portion thereof was sealed by the sealing body, so that a cylindrical nonaqueous electrolyte secondary battery was formed.

### Comparative Example 1

Except for that a tape having no easy-tear lines was used instead of using the tape having an easy-tear line, a battery was formed in a manner similar to that of Example 1.

### [Measurement of Resistance After Initial Charge/Discharge]

The battery of each of Example and Comparative Example was charged to a battery voltage of 4.2 V and was then discharged to a battery voltage of 2.5 V. An internal resistance of the battery after the initial charge/discharge was measured at an alternate current frequency of 1 kHz. Evaluation results are shown in Table 1.

TABLE 1

| | EASY-TEAR | RESISTANCE |
|---|---|---|
| | PORTION | AFTER INITIAL |
| | OF TAPE | CHARGE/DISCHARGE |
| EXAMPLE 1 | YES | 13 mΩ |
| COMPARATIVE | NO | 18 mΩ |
| EXAMPLE 1 | | |

As shown in Table 1, the battery of Example 1 has a low resistance as compared to that of the battery of Comparative Example 1. When the battery was disassembled after the initial charge/discharge, and the state of the electrode body was investigated, the tape of the battery of Example 1 was torn at an easy-tear portion. It is believed that in the battery of Example 1, since the tape was torn at the easy-tear portion when the electrode body was expanded in the initial charge/discharge, a contact area between the exposed portion of the electrode body and an inner circumferential surface of the exterior package can was increased, and as a result, the resistance was reduced. On the other hand, in the battery of Comparative Example 1, it was confirmed that the tape was not torn, and a gap between the exposed portion of the electrode body and the inner circumferential surface of the exterior package can was observed.

### REFERENCE SIGNS LIST

10 nonaqueous electrolyte secondary battery, 11 positive electrode, 12 negative electrode, 13 separator, 14 electrode body, 14e winding-finish end, 15 battery case, 16 exterior package can, 17 sealing body, 18, 19, insulating plate, 20 positive electrode lead, 21 negative electrode lead, 22 groove portion, 23 filter, 24 lower valve, 25 insulating member, 26 upper valve, 27 cap, 2S gasket, 30 positive electrode collector, 31 positive electrode mixture layer, 40 negative electrode collector, 41 negative electrode mixture layer, 42 exposed portion, 50, 60, 70 tape, 51 extension portion, 52 easy-tear line, 53 through-hole, 62 notch

1. A nonaqueous electrolyte secondary battery comprising:
a winding type electrode body which, includes a positive electrode in which positive electrode mixture layers are formed on two surfaces of a positive electrode collector, a negative electrode in which negative electrode mixture layers are formed on two surfaces of a negative electrode collector, and a separator provided between the positive electrode and the negative electrode; and
a bottom-closed cylindrical exterior package can which receives the electrode body,
wherein the electrode body has, at an outermost circumferential surface thereof, an exposed portion at which the negative electrode collector is exposed and is provided with a tape which is adhered on the outermost circumferential surface from a winding-finish side end portion of the negative electrode and past a winding-finish end of the electrode body,
the exposed portion is in contact with an inner circumferential surface of the exterior package can, and
the tape has an extension portion extending from a position overlapping with the winding-finish end of the electrode body to a side opposite to an inner winding direction and has at least one of an easy-tear portion and a tear-start portion in the extension portion.

2. The nonaqueous electrolyte secondary battery according to claim 1,
wherein, in the extension portion of the tape, at least one of the easy-tear portion and the tear-start portion is formed in a region of 1 mm from the position overlapping with the winding-finish end of the electrode body.

3. The nonaqueous electrolyte secondary battery according to claim 1,
wherein the easy-tear portion is at least one easy-tear line formed of a plurality of through-holes linearly disposed along an axial direction of the electrode body.

4. The nonaqueous electrolyte secondary battery according to claim 3,
wherein the number of the at least one easy-tear line is at least two.

5. The nonaqueous electrolyte secondary battery according to claim 1,
wherein the tape is adhered to at least one of two axial-direction end portions of the electrode body.

6. The nonaqueous electrolyte secondary battery according to claim 5,
wherein the tape is adhered to a region of 15 mm from at least one of two axial-direction ends of the electrode body.

7. The nonaqueous electrolyte secondary battery according to claim 5,
wherein, of the two axial-direction end portions of the electrode body, the tape is adhered to the end portion thereof at a bottom-portion side of the exterior package can.
